(19) United States
(12) Patent Application Publication
(10) Pub. No.: US 2005/0198469 A1
(43) Pub. Date: Sep. 8, 2005

(54) Parallel execution optimization method and system

(76) Inventor: Brian Mitchell, North Ogden, UT (US)

Correspondence Address: RANDALL B. BATEMAN;BATEMAN IP LAW GROUP, 8 EAST BROADWAY, SUITE 550, PO BOX 1319, SALT LAKE CITY, UT, 84110, US

(21) Appl. No.: 10/987,938

(22) Filed: Nov. 12, 2004

Related U.S. Application Data
(60) Provisional application No. 60/519,123, filed on Nov. 12, 2003.

(51) Int. Cl. G06F 15/76

(52) U.S. Cl. 712/28

(57) ABSTRACT

A method for parallel execution of computer applications allows many applications to be executed in parallel on a plurality of computational nodes without requiring significant development or reprogramming of the application. Frames, data partitioning, scheduling and the like may be used to allow parallel execution of the various computer applications.

### RELATED APPLICATIONS

The present application claims the benefit of U.S. Provisional Application No. 60/519,123, filed on Nov. 12, 2003.

### BACKGROUND OF THE INVENTION

1. Field of the Invention

The present invention relates generally to data processing methods and systems. Specifically, the invention relates to methods and systems for simultaneously executing an application on multiple computers.

2. Description of the Related Art

Parallel processing remains an elusive goal in data processing systems. Although, many computational tasks are parallelizable, the complexity and inflexibility associated with parallel programming and execution techniques has restricted parallel execution to a few well-behaved problems such as weather forecasting and finite-element analysis. The complicated messaging and coordination mechanisms commonly used in parallel processing applications typically require that an application be rewritten for each execution environment. What is needed are methods and systems that enable parallel execution without the need to rewrite applications for each execution environment.

### SUMMARY OF THE INVENTION

The present invention has been developed in response to the present state of the art, and in particular, in response to the problems and needs in the art that have not yet been fully solved by currently available parallel execution systems. Accordingly, the present invention has been developed to provide an improved method and system for executing applications in a heterogeneous computing environment that overcome many or all of the shortcomings in the art.

In a first aspect of the invention, a method for parallel execution of an application includes providing a module descriptor for at least one module associated with an application, partitioning each module into at least one stage and at least one dataset consistent with the module descriptor to provide a plurality of application partitions, and assigning each application partition to a specific processing frame on a specific processing node.

The module descriptor may include one or more function call descriptors that facilitate invoking the described function from a frame-based scheduling table. The module descriptor may also include partitionability information such as dataset partitionability of each function and dependency information for each function. Dataset partitionability information facilitates distributing a particular function to multiple nodes while dependency information facilitates assigning functions to different processing stages or frames. The partitionability information is used to generate a set of application partitions.

The method for parallel execution of an application may include generating a frame-based scheduling table for the entire application where each application partition is assigned to a specific frame and node. The method may also include executing the scheduling table in a substantially synchronous manner and repartitioning the application and/or rescheduling the application in response to performance metrics collected during execution of the application.

In one embodiment, application partitioning and scheduling is accomplished by estimating execution latency via path analysis using of a weighted graph. The weights may be based on a variety of factors appropriate to parallel execution such as processor speed, storage capacity, communications bandwidth, and the like.

Dataset partitioning functions and dataset assembly functions may be included within each module to facilitate application-specific distribution of datasets associated with a function to multiple processing nodes. Data assembly functions may also be provided that facilitates gathering results from each node to which the data was distributed upon completion of the specified function.

The various elements and aspects of the present invention facilitate executing applications in parallel on a plurality of computational nodes within a heterogeneous computing environment. Applications may be re-deployed within a different environment with little or no development. These and other features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram depicting one example of computing network wherein the present invention may be deployed;

FIG. 2 is a block diagram depicting one embodiment of a parallel execution stack of the present invention;

FIG. 3 is a flow chart diagram depicting one embodiment of a parallel execution method of the present invention;

FIG. 4 is a data flow diagram depicting one example of a parallel execution module of the present invention; and

FIG. 5 is a block diagram depicting one example of a parallel execution scheduling table of the present invention.

### DETAILED DESCRIPTION OF THE INVENTION

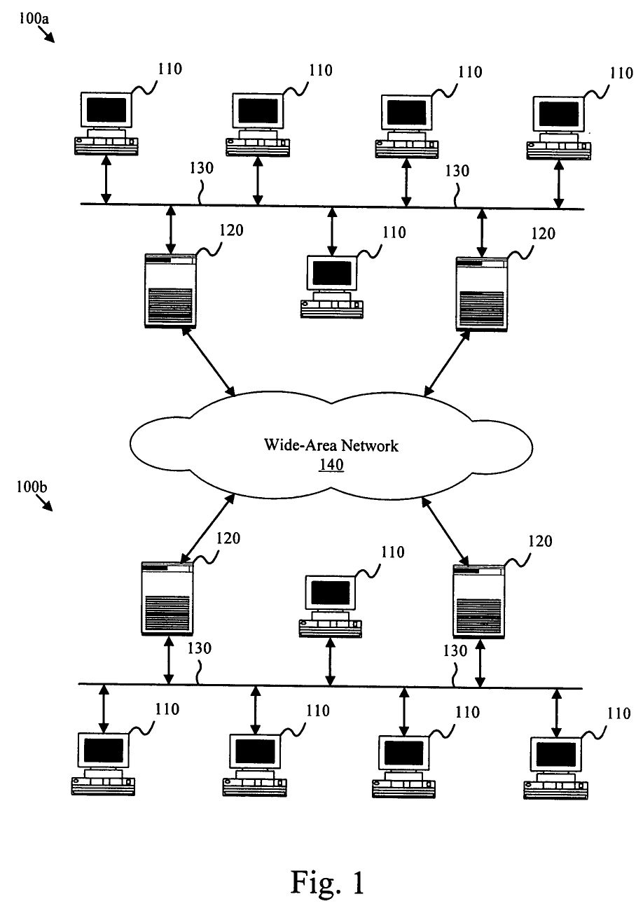

It will be readily understood that the components of the present invention, as generally described and illustrated in the Figures herein, may be arranged and designed in a wide variety of different configurations. Thus, the following more detailed description of the embodiments of the apparatus, method, and system of the present invention, as represented in FIGS. 1 through 5, is not intended to limit the scope of the invention, as claimed, but is merely representative of selected embodiments of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment and the described features, structures, or characteristics may be combined in any suitable manner in one or more embodiments.

FIG. 1 is a schematic block diagram depicting one example of computing environment 100 wherein the present invention may be deployed. The depicted computing environment 100 includes a first computing environment 100a and a second computing environment 100b containing various computing systems and devices such as workstations 110 and servers 120 interconnect by local area networks 130. A wide-area network 140, such as the internet, interconnects the computing environments 100a and 100b.

The computing environment 100 may be a heterogenous computing environment that includes computing devices and systems of widely varying storage capacity, processing performance, and communications bandwidth. Many of the computing devices and systems (computing nodes) may sit idle for considerable periods of time. The present invention provides means and methods to harness the resources of computing networks and environments such as the computing environment 100.

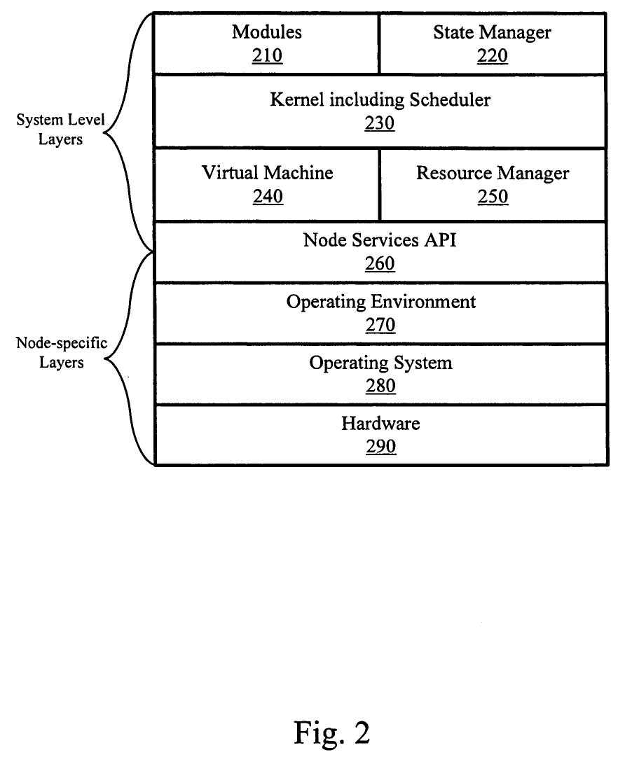

FIG. 2 is a block diagram depicting one embodiment of a parallel execution stack 200 of the present invention. The depicted parallel execution stack 200 includes one or more application modules 210, a state manager 220, a kernel 230, a virtual machine 240, a resource manager 250, a node services API 260, a node environment 270, an operating system 280, and node hardware 290. The parallel execution stack 200 provides one view of one embodiment of a parallel execution system (not shown) of the present invention. The parallel execution stack 200 and associated system facilitate the development, deployment, and execution of applications on multiple computing devices and systems across a networked computing environment such as the computing environment 100 depicted in FIG. 1.

The application modules 210 contain application code in the form of invokable functions. Functions for partitioning and assembling datasets to enable parallel execution of specific functions may also be included within an application module 210. The application modules 210 may also include a module descriptor (not shown). In one embodiment, the module descriptor describes the functions and associated datasets within the module including the function parameters and dependencies.

The state manager 220 tracks the state of an application and associated modules 210. The state manager 220 may also work in conjunction with the kernel 230 to manage execution of modules on various nodes within the computing environment. In one embodiment, the state manager 220 manages entry points within the application modules 210.

The kernel 230 provides a node-independent API for services. In certain embodiments, the kernel 230 is essentially a node-independent operating system. The virtual machine 240 is part of the kernel 230 and provides the appearance of a single system-wide machine.

The resource manager 250 manages the resources of each node in the system (one manager per node) and facilitates access to those resources by the kernel 230. The node services API 260 translates node independent function calls to node-dependent function calls supportable by the node environment 270 and operating system 280. The operating system 280 manages the node specific hardware 290.

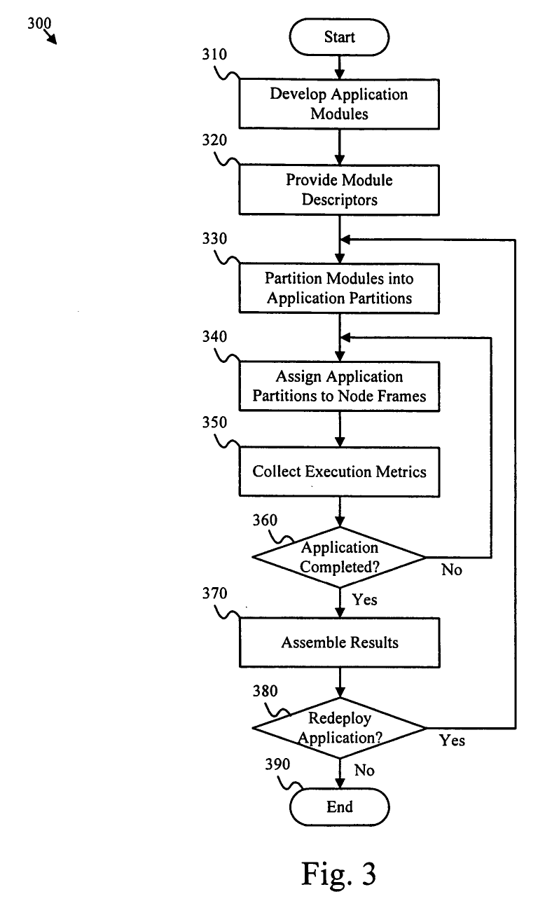

FIG. 3 is a flow chart diagram depicting one embodiment of a parallel execution method 300 of the present invention. The depicted parallel execution method includes a develop application modules step 310, a provide module descriptors step 320, a partition modules step 330, an assign application partitions step 340, a collect execution metrics step 350, an application completed test 360, an assemble results step 370, and a redeploy application test 380. The parallel execution method may be conducted in conjunction with the parallel execution stack 200.

During the develop application modules step 310, functions used by a particular application are developed and packaged (or simply packaged) into application modules usable by the parallel execution stack 200 or the like. Preferably, all dependent functions are packaged in the module to create an independently executable module. During the provide module descriptors step 320, module descriptors that describe entry points into the module and function dependencies are created and associated with an application module such as the application module 210.

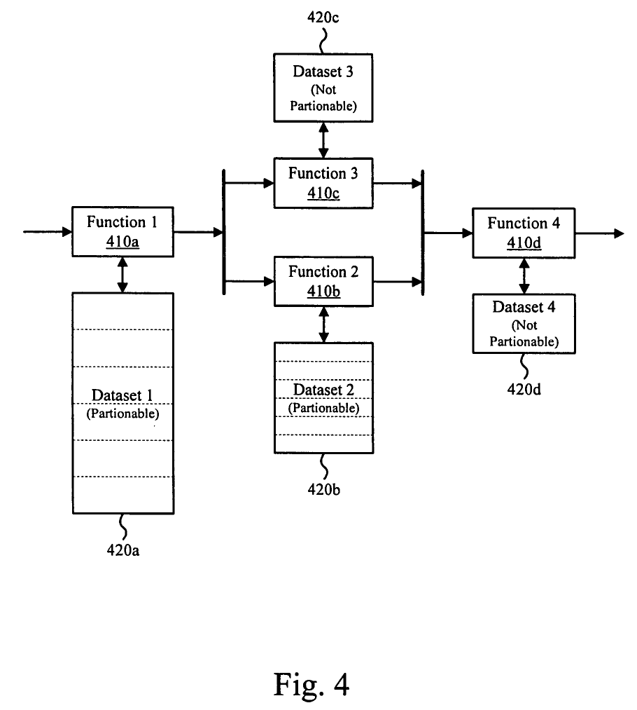

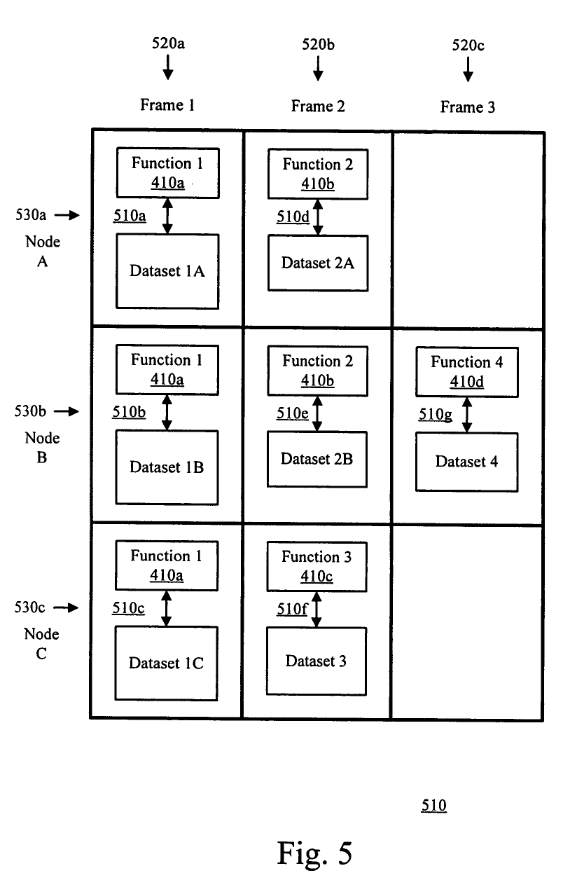

The partition modules step 330 partitions a module or individual functions within a module into one or more application partitions. Partitioning may be directed by an optimization method such as latency minimization using a weighted graph. In one embodiment, dependent functions may be stage partitioned and functions with partitionable datasets may be node partitioned to provide a set of application partitions that are both node and stage partitioned. The assign application partitions step 340 assigns each application partition to a specific frame and node. FIGS. 4 and 5 depict steps 340 and 350 for a particular example.

The collect execution metrics step 350 collects execution metrics while the application in order to improve performance for subsequent execution. During the collection execution metrics step 350 the application may be executed on a frame by frame basis in a substantially synchronous manner as directed by a scheduling table. Executing in a substantially synchronous manner ensures that all dependent functions are computed before advancing to the next frame. The application may specify looping to a previous frame in the schedule table.

The application completed test 360 ascertains whether execution of the application has completed. If the application has not completed the parallel execution method 300 loops to the assign application partitions step 340. In conjunction with the looping to the assign application partitions step 340, the scheduler may loop to a previous execution frame. If the application has completed, the method advances to the assemble results step 370.

The assemble results step 370 assembles results from multiple nodes in a manner specified by the application. The redeploy application test 380 ascertains whether a subsequent run of the application is desired or requested. If a subsequent run is requested the method loops to the partition modules step 330. When returning to the partition modules step 330, the parallel execution method 300 uses the additional information collected during execution (i.e. the collect execution metrics step 350,) to optimize partitioning for subsequent runs of the application.

FIG. 4 is a data flow diagram depicting one example of a parallel execution module 400 of the present invention. The depicted parallel execution module includes one or more functions 410 and associated datasets 420, and function dependencies 430. While the parallel execution module is shown graphically, a module descriptor (not shown) may be used to specify the same type of information in processing convenient form such as one or more dependency lists, XML statements, or binary codes.

In the depicted example, the dependency 430a shows that functions 2 (410b) and 3 (410c) are dependent on function 1 (410a). Additionally, the dependency 430b indicates that function 4 (410d) is dependent on functions 2 (410b) and 3 (410c). Given the stated dependencies, function 1 (410a) must be processed first and function 4 (410d) must be processed last. The scheduler within the kernel 230 may use dependency information to stage partition the functions within a module.

In addition to dependency information that facilitates stage partitioning, dataset partitionability information may be provided by a module descriptor. In the depicted example, datasets 1 (420a) and 2 (420b) are partitionable while datasets 3 (420c) and 4 (420d) are not. Partitionable datasets may be distributed to more than one node and facilitate parallel execution.

FIG. 5 is a block diagram depicting one example of a parallel execution scheduling table 500 of the present invention. The depicted scheduling table 500 includes tasks 510 comprising functions 410 and datasets 420, that are scheduled for execution (assigned) during specific frames 520, on specific nodes 530. The depicted scheduling table 500 is a specific scheduling solution that correlates to the parallel execution module 400 depicted in FIG. 4.

As depicted, function 1 (410a) is dataset partitioned onto nodes A, B, and C (530a, 530b, 530c) and executed during frame 1 (520a). The dataset associated with function 3 is non-partitionable. Function 3 is also dependent on function 1 (410a). As a result function 3 (410c) is stage partitioned (from function 1) and assigned to execute on node C (530c) during frame 2 (520b).

The dataset associated with function 4 (410d) is non-partitionable and function 4 is dependent on function 3 and is therefore assigned to node B (530b) during frame 3 (520c). The dataset associated with function 2 (410b) is partitionable. As a result, function 2 (410b) is node partitioned and assigned to nodes A and B (530a and 530b) during frame 2 (520b).

The present invention provides means and methods to execute applications in parallel on a plurality of computational nodes within a heterogeneous computing environment. The present invention eases the development and deployment of parallel execution applications. Applications may be redeployed within a different environment with little or no development.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method for executing an application on a plurality of processing nodes, the method comprising:
providing a module descriptor for at least one module associated with an application;
partitioning each module into at least one stage and at least one dataset consistent with the module descriptor to provide a plurality of application partitions; and
assigning each application partition to a specific processing frame on a specific processing node.

2. The method of claim 1, further comprising repartitioning the application in response to performance metrics collected during execution of the application.

3. The method of claim 1, further comprising executing the plurality of application partitions in a substantially synchronous manner.

4. The method of claim 1, wherein the module descriptor includes dataset partitionability information.

5. The method of claim 1, wherein the module descriptor includes function dependency information.

6. The method of claim 1, wherein the module descriptor includes at least one function call descriptor.

7. The method of claim 1, further comprising redirecting a function call to another processing node.

8. The method of claim 1, wherein partitioning comprises estimating execution latency.

9. The method of claim 1, wherein estimating execution latency comprising path analysis using a weighted graph.

10. The method of claim 1, further comprising aggregating a maximally partitioned application into a plurality of application partitions.

11. The method of claim 1, wherein providing the module descriptor comprises providing an XML file.

12. The method of claim 1, further comprising executing callback functions.

13. The method of claim 1, further comprising providing a dataset partitioning function.

14. The method of claim 1, further comprising providing a dataset assembly function.
